(19) United States
(12) Patent Application Publication
(10) Pub. No.: US 2001/0004485 A1
(43) Pub. Date: Jun. 21, 2001

(54) Thermal transfer sheet

(76) Inventors: Yohnosuke Takahashi, Shizuoka-ken (JP); Tomizo Namiki, Shizuoka-ken (JP); Mikio Totsuka, Shizuoka-ken (JP)

Correspondence Address: SUGHRUE, MION, ZINN, MACPEAK & SEAS, PLLC, 2100 PENNSYLVANIA AVENUE, N.W. Suite 800, WASHINGTON, DC, 20037-3213, US

(21) Appl. No.: 09/727,072

(22) Filed: Dec. 1, 2000

(30) Foreign Application Priority Data
Dec. 1, 1999 (JP) 11-342093

(51) Int. Cl. B41M 5/26

(52) U.S. Cl. 428/195; 347/105

(57) ABSTRACT

A thermal transfer sheet including a substrate, and a thermal transfer layer provided on the substrate and containing an inorganic or metal pigment, a binder, and a precipitation inhibitor. An image with high metallic gloss or whiteness and with a uniform color tone can be formed on the thermal transfer sheet. The precipitation inhibitor is preferably a thixotropic agent, and the inorganic or metal pigment is preferably a pearl pigment, an inorganic white pigment, or a metal fine powder pigment.

### BACKGROUND OF THE INVENTION

1. Field of the Invention

The present invention relates to a thermal transfer sheet that can be used in preparing a pre-press color proof (DDCP: direct digital color proof) in the field of printing, and in preparing an image to be displayed. More specifically, the present invention relates to a thermal transfer sheet which is suitable for a use in cases in which images to be formed on the thermal transfer sheet have a metallic color tone and/or white color tone.

2. Description of the Related Art

Generally, proof printing is performed in order to confirm the final finish of a printed matter. During this process, a color proof is utilized for proofing of color printed matter.

Yellow (Y), cyan (C), magenta (M), and black (K) are used as the standard colors for hues of actual printed matter. However, hues with luster or gloss of a metallic tone (occasionally referred to as “metallic gloss”, hereinafter), white color, or the like may also be used in special printing.

Conventionally, as a method for obtaining an image with metallic gloss, methods in which a metallic glossy image with a gold or silver color or the like is formed by utilizing so-called special color inks, i.e., printing inks to which a metal powder or the like has been added, have been known. Moreover, in a method for obtaining a white color image, an ink formed of an inorganic white pigment such as titanium dioxide has been utilized.

In recent years, technical innovations of image formation by thermal transfer processes have been remarkable, and methods in which an image having metallic gloss is formed by a thermal transfer process are also known. For example, a thermal transfer material for metallic gloss printing, which is provided with an ink layer containing a metal powder pigment and a dye which is added as required, is disclosed in Japanese Patent Application Laid-Open (JP-A) No. 63-290789. Also, JP-A No. 7-25164 discloses a thermal mass transfer donor sheet, on which a layer formed of metal flakes and a thermoplastic polymer is provided.

Although a color proof as a sample for color proofing may be prepared by any of various methods, there has been a demand for color proofs of high resolution in which images are formed digitally, as a result of the recent improvements and digitization of printed matter preparation techniques. For example, JP-A Nos. 7-117359 and 7-132678 disclose methods for preparing a color proof, which utilize a thermal head printer to digitally form an image.

The same requirements as those described above have been demanded of color proofs for printed matter having metallic gloss or a white color printed portion.

That is, also in the case of printed matter having metallic gloss or a white color printed portion, it is necessary to confirm the finish of the printed matter in advance by using a color proof. Since the color proof is used for presuming the finish of the printed matter, excellent performance is required for its quality, especially for the uniformity of density of color materials.

Currently, high quality materials for color proofs of the standard hues of Y, M, C, and K are commercially available. However, the present situation is that, for digital color proofs of hues having a metallic tone such as a gold or silver color or the like, or of hues having excellent whiteness, materials of a sufficient quality to enable use thereof as a print proof are not yet available.

That is, when a digital color proof material, i.e., a thermal transfer sheet, having a metallic tone such as a gold or silver color, or having a white hue is to be prepared, a metal powder pigment or the like, which has a large particle diameter and a high specific gravity as compared to the organic pigments of the above-described Y, M, C, K and the like, must be used. Since the metal powder pigment tends to precipitate in a coating solution, it may not be possible to prepare a coating solution with an excellent dispersibility. As a result, the uniformity of density of the color material may not be maintained in the color proof, so that the color proof is not suitable for a print proof.

In the case of a highly viscous vehicle such as a printing ink used for printing, a dispersed state with a certain degree of uniformity can be maintained even if the pigment has a large particle diameter and a high specific gravity such as a metal powder pigment or the like. On the contrary, in the case of a color proof, since the thickness of the color material layer is several μm or less, a coating solution with a low viscosity must be used in order to form a thin layer of several μm or less by coating. Therefore, when a pigment with a large particle diameter and a high specific gravity is used as the color material, even if a dispersed coating solution with a certain uniformity is once prepared, precipitation easily occurs in a short time, and the pigment precipitates while the coating solution being coated on the substrate. Thus, it is difficult to stably prepare a digital color proof material having a color material layer with a uniform pigment content. As a result, there has been a problem with such color materials in that the hue and/or gloss of formed images as well are not uniform, so that the color materials are not suitable for use as materials for a color proof.

Such a problem also arises in digital color proofs for white color printing which utilize an inorganic white pigment such as titanium oxide, since the inorganic white pigment has a high specific gravity.

The current situation is that there has not yet been developed such a thermal transfer material which is such that when a metal pigment or an inorganic pigment having a high specific gravity and/or a large particle diameter is used as the color material as described above, precipitation and the like of the pigment in the coating solution does not occur, and the pigment is uniformly contained in the color material layer formed on the substrate.

### SUMMARY OF THE INVENTION

A purpose of the present invention is to solve the above-described problems of the conventional art and to achieve the following objects. That is, an object of the present invention is to provide a thermal transfer sheet which enables formation of an image with high metallic gloss or whiteness and with a uniform color tone. Another object of the present invention is to provide a thermal transfer sheet in which, during the manufacturing process, a deterioration of the pigment dispersibility due to precipitation of an inorganic or metal pigment in the coating solution is suppressed, and which has a thermal transfer layer in which the inorganic or metal pigment is dispersed uniformly.

As a result of diligent studies by the present inventors on stability of dispersion in cases in which pigments with a large particle diameter and/or a high specific gravity are used as a color material, the following findings were obtained.

(1) When a pigment having a large particle size and/or a high specific gravity such as a mica pigment, a metal pigment or an inorganic white pigment is used as a color material, in a conventional dispersant, precipitation tends to occur gradually even in a dispersant having a high dispersive power, so that a stability of dispersion which is sufficient to achieve a certain uniform density of the color material that is necessary for use as a color proof cannot be ensured.

(2) Mutually contradictory properties are required in that, while a certain degree of viscosity is necessary for ensuring the stability of dispersion of a pigment with a high specific gravity, a low viscosity is required for formation of a thin film.

The present invention is provided on the basis of the above-described findings by the present inventors, and provides measures to solve the above-described problems. That is, the present invention is a thermal transfer sheet including a substrate, and a thermal transfer layer provided on the substrate and containing, a binder, a precipitation inhibitor and an inorganic or metal pigment.

Namely, the present invention is a thermal transfer sheet having a thermal transfer layer on a substrate, wherein the thermal transfer layer is formed by applying a coating solution containing at least an inorganic or metal pigment, a precipitation inhibitor, and a binder onto the substrate, and then by drying the coating solution.

In accordance with an aspect of the present invention, the precipitation inhibitor is a thixotropic agent.

In accordance with another aspect of the present invention, the thixotropic agent is a higher aliphatic compound.

In accordance with still another aspect of the present invention, the thixotropic agent is a fatty acid amide or polyethylene oxide.

In accordance with still another aspect of the present invention, the inorganic or metal pigment is a pearl pigment or a metal fine powder pigment.

In accordance with still another aspect of the present invention, the pearl pigment is a mica pigment.

In accordance with a further aspect of the present invention, the inorganic or metal pigment is in the form of tabular grains having a particle thickness of 0.05 to 0.7 μm and a particle size of 1 to 50 μm.

In accordance with a still further aspect of the present invention, the inorganic pigment is a white pigment.

In accordance with a still further aspect of the present invention, the white pigment is titanium oxide or calcium carbonate.

In accordance with still another aspect of the present invention, the thermal transfer layer further contains a wetting dispersant.

In accordance with a still further aspect of the present invention, the binder is wax or a thermoplastic polymer.

In accordance with yet another aspect of the present invention, the thermal transfer sheet further includes a light-to-heat conversion layer provided between the substrate and the thermal transfer layer.

### DESCRIPTION OF THE PREFERRED EMBODIMENTS

In the thermal transfer sheet in accordance with the present invention, the thermal transfer layer provided on the substrate contains a precipitation inhibitor together with an inorganic or metal pigment. That is, the present invention is a thermal transfer sheet, which includes at least a thermal transfer layer on a substrate, wherein the thermal transfer layer is formed by applying a coating solution containing at least an inorganic or metal pigment, a precipitation inhibitor, and a binder onto the substrate, and then by drying the coating solution.

The photosensitive transfer sheet of the present invention will be described in detail hereinafter, and a method of forming images which utilizes the thermal transfer sheet of the present invention will also be explained through this description. While pigments such as a pearl pigment and/or a metal fine powder pigment (occasionally referred to as “metallic glossy pigments”, hereinafter) are mainly described as examples, the same description is applicable to inorganic white pigments as well.

The thermal transfer sheet of the present invention has at least a thermal transfer layer on a substrate, and if necessary, other layers such as a light-to-heat conversion layer, a heat-sensitive peelable layer, and a cushion layer may be provided.

Thermal Transfer Layer

The thermal transfer layer is a layer containing an inorganic or metal pigment and has a uniform glossiness. The thermal transfer layer contains at least an inorganic or metal pigment, a precipitation inhibitor, and a binder, and may contain other components such as a non-glossy coloring agent, or a wetting dispersant if necessary. When the pigment is an inorganic white pigment, a thermal transfer layer of a white color hue is formed.

A thermal transfer layer having a uniform glossiness means a layer containing a metallic glossy pigment (occasionally referred to as “metallic glossy thermal transfer layer”, hereinafter) such as a pearl pigment or a metal fine powder pigment (described later) so as to have metallic tone luster and/or gloss (metallic gloss), and more specifically, a layer having a glossiness of 1.2 or more when the glossiness of the surface thereof is measured by the method described hereafter.

Measurement of Glossiness

A spectrophotometric calorimeter for measuring glossiness (e.g., CM-512m3 manufactured by Minolta Co., Ltd.) is utilized to measure the glossiness. Xenon pulse light is irradiated on a sample surface from directions at angles of 25° and 75° from the vertical axis direction of the sample surface. A photoreceptive sensor provided in a direction at an angle of 45° from the vertical axis receives the reflected light and spectrophotometric colorimetry is carried out on the reflected light to obtain the L* value thereof. The glossiness is defined as the ratio of the L* value at incidence of 25° and that at incidence of 75° (i.e., L*(25°)/L*(75°)).

Inorganic or Metal Pigment

An inorganic or metal pigment is used as the color material in the thermal transfer layer to form a glossy thermal transfer layer having a metallic tone hue including a gold or silver color or the like (i.e., a metallic glossy thermal transfer layer), or a white thermal transfer layer having a high degree of whiteness.

Examples of the inorganic or metal pigment include metallic glossy pigments such as known metal fine powder pigments and pearl pigments, and inorganic white pigments such as oxide or carbonate, and can be suitably selected in accordance with the object.

Examples of the pearl pigment include natural pearl essence, mercury chloride, basic white lead, bismuth oxychloride, mica and the like. Among these pigments, a mica pigment is especially preferable from the standpoint of safety and cost.

Examples of the metal fine powder pigment include fine powder pigments of aluminum, gold, silver, copper, zinc and the like. Among these pigments, aluminum is especially preferable from the standpoint of gloss, cost and the like.

Various forms of the pearl pigment and the metal fine powder pigment can be used, and a pigment in a certain form can be suitably selected in accordance with the object. However, the pigments are preferably in the form of tabular grains from the standpoint of obtaining a high degree of glossiness with a low filled amount.

For the specific form of the tabular particles, particles having a particle thickness of 0.05 to 0.7 μm and a particle size of 1 to 50 μm are preferable, and those having a particle size of 5 to 30 μm are more preferable.

When the particle thickness exceeds 0.7 μm, the quality of the image along with the glossiness occasionally deteriorates. When the particle size is less than 1 μm, the glossiness occasionally deteriorates, and when the particle size exceeds 50 μm, the resolution as well as the surface smoothness of the thermal transfer layer is adversely affected, so that a uniform glossiness may not be able to be obtained.

Among the various glossy pigments, a mica pigment is especially preferable as a pigment having a tabular form, and titanium dioxide covered mica having a laminated structure of a titanium dioxide film on the mica particle is most preferable.

In case of titanium dioxide covered mica, when the particle thickness exceeds 0.7 μm, the interference effect of light due to light reflection at the boundary surface between the mica and the titanium dioxide may decrease, so that the glossiness occasionally deteriorates. When the particle size is 1 μm or less, the glossiness may deteriorate. When the particle size exceeds 50 μm, the surface smoothness of the thermal transfer layer may be adversely affected, so that a uniform metallic gloss may not be able to be obtained.

The particle size refers to a longitudinal diameter of the tabular particle, and can be measured, for example, by an optical microscope or an electron microscope.

Examples of the inorganic white pigment include inorganic compounds such as metal oxides and metal carbonates.

Preferable examples of the metal oxide include titanium dioxide, aluminum oxide, zinc oxide, silicon oxide, and magnesium oxide. Preferable examples of the metal carbonate include calcium carbonate and the like.

The particle diameter of the inorganic white pigment is preferably 0.01 to 10 μm, and more preferably 0.1 to 5 μm.

While the amount of the inorganic or metal pigment contained in the thermal transfer layer can be suitably selected in accordance with the object such as the hue or the glossiness of the formed image, the amount is preferably 0.1 to 5 g/m², and more preferably 0.3 to 2 g/m².

Precipitation Inhibitor

Examples of the precipitation inhibitor are compounds exhibiting thixotropic properties, which maintain the dispersibility of the pigment in the coating solution when a pigment with a large particle diameter and/or a high specific gravity such as the above-described inorganic or metal pigments is used as the color material. For example, a thixotropic agent is preferable.

When the thixotropic agent is contained in a dispersion solution (a coating solution for thermal transfer layer) which contains an inorganic or metal pigment, the thixotropic agent functions, due to the thixotropic properties thereof, to increase the viscosity of the dispersion solution while the dispersion solution is in a stationary state, thereby preventing the pigment from precipitating. When a shearing force is exerted during the process of coating the dispersion solution onto the substrate, the thixotropic agent functions to lower the viscosity of the dispersion solution markedly, thereby enabling filtration of the dispersion solution and coating thereof to a uniform thickness on the substrate.

Therefore, the thixotropic properties of the thixotropic agent are preferably utilized since the greater the thixotropic properties, the better the stability of dispersion of the pigment can be ensured, and a thermal transfer layer with a uniform content of pigment can be formed stably by the coating solution in which the pigment is dispersed uniformly.

It is known that, for a thixotropic agent exhibiting thixotropic properties, usually, a portion of the thixotropic agent precipitates in the dispersion solution and exhibits a three-dimensional network structure.

Preferable examples of the thixotropic agent include polyamide waxes, metal soaps, organic bentonite, polyethylene oxide compounds, and hydrogenated castor oil wax, which tend to precipitate to form a needle crystal or a laminated crystal. Fine particles of inorganic substances such as fine powder of silicon dioxide are also used effectively as the thixotropic agent.

Among these thixotropic agents, polyamide waxes, polyethylene oxide compounds, and metal soaps are especially preferable.

Examples of the polyamide waxes include stearic acid amides, behenic acid amides, and straight chain amides of myristic acid, lauric acid, palmitic acid, and the like. Polyvalent amides including bivalent amides or greater are more preferable than monovalent amides from the standpoint of exhibiting excellent thixotropic properties. Examples of the metal soaps include metal salts such as stearic acid, palmitic acid and the like. For the metal salts, salts of aluminum, calcium, magnesium and the like are preferable.

The added amount of the precipitation inhibitor (excluding polyethylene oxide compounds) in the thermal transfer layer is preferably 0.01 to 0.3 parts by weight per 1 part by weight of the above-described inorganic or metal pigment.

If the added amount is less than 0.01 parts by weight, the precipitation preventing effect is low, so that the dispersibility of the inorganic or metal pigment may not be maintained uniform. If the added amount exceeds 0.3 parts by weight, the compound exhibiting thixotropic properties can cause image defects or the like due to crystallization of the compound in the layer or the like.

Preferable examples of the polyethylene oxide compounds include compounds having a molecular weight of 300 to 50,000. In the case of such compounds, the added amount thereof in the thermal transfer layer is preferably 0.02 to 0.4 parts by weight per 1 part by weight of the above-described inorganic or metal pigment.

If the added amount is less than 0.02 parts by weight, the precipitation preventing effect is low, so that the dispersibility of the inorganic or metal pigment may not be maintained uniform. If the added amount exceeds 0.4 parts by weight, problems such as the slowing down of the development speed may arise.

The above-described precipitation inhibitors may be used alone, or two or more types may be used in combination.

By using such a precipitation inhibitor with high thixotropic properties, even if low viscosity is required in production thereof to enable good coating, a pigment with a large particle size and/or a high specific gravity can be dispersed uniformly and maintained uniform so as to enable uniformity of the components in the layer formed by coating. Moreover, the density of the pigment is improved, so that formation of a layer with higher metallic gloss or with excellent whiteness is possible. Further, even if a coating solution, in which the glossy pigment is dispersed, is subjected to a process such as filtering in the production process, clogging of the filter hardly occurs and the process can be carried out easily.

Wetting Dispersant

It is preferable to add a wetting dispersant in the thermal transfer layer. The wetting dispersant is preferably a dispersant which can act upon the surface of the pigment particle to change the wettability with the solvent or the binder, accelerate the dispersion of the inorganic or metal pigment, and suppress cohesion of the pigment. Moreover, a wetting dispersant which can improve the re-dispersibility of the pigment when the pigment precipitates is preferable. Therefore, for example, the wetting dispersant can be suitably selected from among surfactants having such properties.

Examples of the surfactant include phosphoric ester surfactants such as polyamide amide phosphate; polycarbonate such as polyacrylate and amine salts thereof; anionic compounds such as carboxylate sulfic ester salts (e.g., sodium oleate), and sulfonic acid salts; and cationic compounds such as oleylamine acetate and aminopropylamine diolate.

Among these surfactants, amine salts of polycarbonate are particularly preferable.

The added amount of the wetting dispersant is preferably 0.001 to 0.10 parts by weight, and more preferably 0.003 to 0.05 parts by weight per 1 part by weight of the inorganic or metal pigment.

Binder

The above-described binder is preferably a binder which has low cohesive strength and which is selected from waxes, thermoplastic polymers, and the like. A binder containing wax or a binder mainly formed from wax is more preferable.

That is, each particle of the inorganic or metal pigment contained in the thermal transfer layer as the color material has a particle diameter of 1 to 50 μm, which is, in general, considerably larger than that of the non-glossy coloring agent (organic pigment; particle diameter of about 0.1 to 0.3 μm) used in forming an image with the standard colors (described later), so that the thickness of the thermal transfer layer is large. In order to maintain the resolving power required in this state, it is necessary to lower the cohesive strength of the thermal transfer layer.

Examples of the wax include plant waxes such as candelilla wax, carnauba wax, rice wax, haze wax, and jojoba oil; animal waxes such as beeswax, lanolin, and spermaceti; petroleum waxes such as paraffin wax, montan wax, and petrolatum; synthetic waxes such as Fischer-Tropsch wax, and polyethylene wax; denatured waxes such as derivatives of montan wax; and fatty acids such as lauric acid, palmitic acid, stearic acid, 12-hydroxystearic acid, and the like.

As the thermoplastic polymer, an amorphous organic polymer having a softening point of 40 to 150° C. can be used. Examples of the thermoplastic polymers include butyral resins; polyamide resins; polyethyleneimine resins; sulfonamide resins; polyesterpolyol resins; petroleum resins; homopolymers or copolymers of styrene, derivatives thereof or substituted styrene, such as styrene, vinyltoluene, α-methylstyrene, 2-methylstyrene, chlorostyrene, vinylbenzoic acid, sodium vinylbenzenesulfonate, and aminostyrene; homopolymers or copolymers of vinyl monomers such as methacrylates or methacrylic acid (such as methyl methacrylate, ethyl methacrylate, butyl methacrylate, and hydroxyethyl methacrylate), acrylates or acrylic acid (such as methyl acrylate, ethyl acrylate, butyl acrylate, and α-ethylhexyl acrylate), dienes (such as butadiene and isoprene), acrylonitrile, vinyl ether, maleic acid, maleic acid esters, maleic anhydride, cinnamic acid, vinyl chloride, and vinyl acetate.

Due to the above-described characteristic of these waxes and thermoplastic polymers to lower the cohesive strength, a binder formed of two or more types, including a wax, in combination is preferable.

The amount of the binder contained in the thermal transfer layer is preferably 0.1 to 5 g/m², and more preferably 0.3 to 2 g/m².

If a plurality of image layers (thermal transfer layers or non-thermal transfer layers having images formed thereon) are stacked sequentially on the same image receiving sheet to prepare a multicolor image, a plasticizer is preferably included in the thermal transfer layers in order to improve the tight contact between the images.

Examples of the plasticizer include phthalates such as dibutyl phthalate, di-n-octyl phthalate, di(2-ethylhexyl) phthalate, dinonyl phthalate, dilauryl phthalate, butyllauryl phthalate, and butylbenzyl phthalate; esters of aliphatic divalent acids, such as di(2-ethylhexyl) adipate and di(2-ethylhexyl) sebacate; triesters of phosphoric acid, such as tricresyl phosphate and tri(2-ethylhexyl) phosphate; polyol polyesters, such as polyethylene glycol esters; and epoxy compounds such as esters of epoxidized fatty acids.

In addition to these typical plasticizers, acrylates such as polyethylene glycol dimethacrylate, 1,2,4-butanetriol trimethacrylate, trimethylolethane triacetate, pentaerythritol triacrylate, pentaerythritol tetraacrylate, and dipentaerythritol polyacrylate, are also suitable for use in the present invention depending on the type of the binder used. These plasticizers may be used in a combination of two or more.

Generally, the added amount of the plasticizer in the thermal transfer layer is such that the content ratio (weight ratio) of the total amount of the pigment and the binder to the amount of the plasticizer is preferably 100:0.5 to 1:1, and more preferably 100:2 to 3:1.

In addition to the above-described components, a surfactant, a thickener, and the like may be added to the thermal transfer layer as needed.

The thickness (dry layer thickness) of the thermal transfer layer preferably ranges from 0.2 to 3.0 μm, and more preferably from 0.4 to 2.0 μm.

Non-Glossy Coloring Agent

In a preferred aspect of the present invention, an organic or inorganic non-glossy coloring agent may also be used in combination with the above-described inorganic or metal pigment in the thermal transfer layer in order to adjust the hue of the image. Various hues can be formed by changing the amount of the non-glossy coloring agent used in combination.

The non-glossy coloring agent refers to a coloring agent in which, in the case of a color material layer (occasionally referred to as a “non-glossy thermal transfer layer”, hereinafter) only including the non-glossy coloring agent as the color material, the glossiness of the color material layer as measured by the above-described method for measuring the glossiness (L*(25°)/L*(75°)) is less than 1.2. The non-glossy coloring agent can be suitably selected from color materials such as known pigments and dyes. Among such color materials, organic pigments which match or whose color tones are close to pigments used for a printing color proof (yellow, magenta, cyan, and black) are preferable. The type and the amount of the non-glossy coloring agent can be suitably selected in accordance with the object. Non-glossy coloring agents are described in detail, for example, in JP-A No. 59-97140. Preferable examples of the non-glossy coloring agent include azo pigments, phthalocyanine pigments, anthraquinone pigments, dioxazine pigments, quinacridone pigments, isoindolinone pigments, and nitro pigments. Specific examples are given below.

1) Examples of yellow pigment include Hansa Yellow G, Hansa Yellow 5G, Hansa Yellow 10G, Hansa Yellow A, Pigment Yellow L, Permanent Yellow NCG, Permanent Yellow FGL, and Permanent Yellow HR.

2) Examples of red pigment include Permanent Red 4R, Permanent Red F2R, Permanent Red FRL, Lake Red C, Lake Red D, Pigment Scarlet 3B, Bordeaux 5B, Alizarin Lake, and Rhodamine Lake B.

3) Examples of blue pigment include Phthalocyanine Blue, Victoria Blue Lake, and Fast Sky Blue.

4) Examples of black pigment include carbon black and the like.

The average particle diameter of the non-glossy coloring agent is preferably in a range of 0.03 to 1 μm, and more preferably in a range of 0.05 to 0.5 μm.

The thermal transfer layer is formed by applying a coating solution for forming the thermal transfer layer (a coating solution for thermal transfer layer), which is prepared by dissolving or dispersing the inorganic or metal pigment, the precipitation inhibitor, the binder, and other components as needed in a solvent, onto a substrate by a conventional application method, and then drying the coating solution.

If the coating solution for thermal transfer layer is maintained, after preparation and before application thereof, in a state in which the glossy pigment is dispersed in a stable manner due to the high viscosity resulting from the thixotropic properties of the thixotropic agent, and if an appropriate shearing force is exerted at a stage of coating the solution onto the substrate, the viscosity of the coating solution is lowered to a certain degree such that coating of a thin layer is possible, thereby enabling the coating solution in a state in which the glossy pigment is uniformly dispersed to be coated with a uniform thickness. As a result, a thermal transfer layer exhibiting a uniform glossiness can be formed.

Examples of the solvent which can be used for preparing the coating solution for thermal transfer layer include alcohols such as ethyl alcohol and propyl alcohol; ketones such as acetone and methylethyl ketone; esters such as ethyl acetate; aromatic hydrocarbons such as toluene and xylene; ethers such as tetrahydrofuran and dioxane; amides such as DMF and N-methylpyrrolidone; and cellosolves such as methyl cellosolve. The solvent can be suitably selected from among these in accordance with the condition of the thermal transfer layer to be formed such as presence or absence of a light-to-heat conversion layer and the like. The solvent may be used alone, or two or more types may be used in combination.

In order to prevent the thermal transfer layer from becoming scratched, a protective covering film such as a polyethylene terephthalate sheet, a polyethylene sheet, or the like may be laminated on the surface of the thermal transfer layer.

Light-to-Heat Conversion Layer

When an image forming process is performed on the thermal transfer sheet of the present invention by using laser light as a light source, a light-to-heat conversion layer is provided between the substrate and the thermal transfer layer, or a substance capable of converting light to heat (a laser light absorbing material) is contained in the thermal transfer layer.

In the light-to-heat conversion layer, a substance capable of converting light to heat, and a binder resin (occasionally referred to as a “binder polymer for light-to-heat conversion layer”, hereinafter) are contained, and other components are contained if necessary.

The substance capable of converting light to heat is usually a laser light absorbing material such as a dye capable of absorbing laser light. Examples of such a dye (a pigment or the like) include a black pigment such as carbon black; a pigment, which is a macrocyclic compound capable of absorbing rays in regions ranging from the visible region to the near infrared region, such as phthalocyanine, naphthalocyanine, or the like; an organic dye (such as a cyanine dye exemplified by an indolenine dye, an anthraquinone dye, an azulene dye, a phthalocyanine dye, or the like) which is used as a laser-absorbing material for high-density laser recording in an optical disk or the like; and a dye formed by an organometallic compound such as dithiol/nickel complex or the like.

Preferably, in order to increase image recording sensitivity, the light-to-heat conversion layer is as thin as possible. For this reason, it is preferable to use an infrared absorption dye such as a cyanine dye or a phthalocyanine dye, which has a large light absorptance in a region of laser light wavelengths.

An inorganic material, such as a metallic material, can also be used as the laser light absorbing material. The metallic material is used in the form of particles (e.g., blackened silver).

The optical density of the substance capable of converting light to heat in a region of laser absorbing wavelengths is preferably in a range of 0.1 to 2.0, and more preferably in a range of 0.3 to 1.2.

If the optical density is less than 0.1, the sensitivity of the thermal transfer sheet may deteriorate. If the optical density exceeds 2.0, the substance having such an optical density may be disadvantageous from the standpoint of the manufacturing cost.

Examples of the binder polymer for light-to-heat conversion layer include resins which have high glass transition points and high thermal conductivity, namely, typical heat resistant resins such as polymethyl methacrylate, polycarbonate, polystyrene, ethylcellulose, nitrocellulose, polyvinyl alcohol, gelatin, polyvinylpyrrolidone, polyparabanic acid, polyvinylchloride, polyamide, polyimide, polyetherimide, polysulfone, polyethersulfone, and aramide.

More specifically, in a case in which image recording is performed by arranging a plurality of high power lasers such as multi-mode lasers, a polymer having an excellent heat resistance is preferably used. Moreover, a polymer whose glass transition point (Tg) is in a range of 150 to 400° C. and whose temperature (Td) at which the weight of the polymer is reduced 5% by weight is 250° C. or more (Td is measured by the TGA method, where the air temperature is increased by 10° C./minute) is used more preferably, and a polymer whose Tg is in a range of 220 to 400° C. and whose Td is 400° C. or more is used most preferably.

The light-to-heat conversion layer can be formed by a process including preparing a coating solution (i.e., a coating solution for light-to-heat conversion layer) by dissolving the substance capable of converting light to heat and the binder polymer for light-to-heat conversion layer in an organic solvent, applying the coating solution to the surface of the substrate, and then drying the coating solution.

Examples of the organic solvent for dissolving the binder polymer for light-to-heat conversion layer include 1,4-dioxane, 1,3-dioxolane, dimethyl acetate, N-methyl-2-pyrrolidone, dimethylsulfoxide, dimethylformamide, γ-butyrolactone and the like.

The method used for application of the coating solution for light-to-heat conversion layer can be suitably selected from conventional application methods.

Drying is normally conducted at or below 300° C., and preferably at or below 200° C. More preferably, the drying temperature is in a range of 80 to 150° C., if polyethylene terephthalate is used as the substrate.

In the light-to-heat conversion layer thus formed, the solids weight ratio of the substance capable of converting light to heat to the binder polymer for light-to-heat conversion layer (i.e., the substance capable of converting light to heat:binder) is preferably in a range of 1:20 to 2:1, and more preferably in a range of 1:10 to 2:1.

If the amount of the binder is too small, the cohesive strength of the light-to-heat conversion layer is so small that the light-to-heat conversion layer is liable to be transferred together with the image when the formed image is transferred to an image receiving sheet, thus causing unpreferable color mixing. On the other hand, if the amount of the binder is too large, the sensitivity may deteriorate because the light-to-heat conversion layer needs to be made thicker in order to attain a fixed light absorption ratio.

The thickness of the light-to-heat conversion layer is preferably in a range of 0.03 to 0.8 μm, and more preferably in a range of 0.05 to 0.3 μm.

Further, the light-to-heat conversion layer preferably has a peak absorbance (optical density) in the range from 0.1 to 1.3, and preferably from 0.2 to 1.1, in a wavelength region of 700 to 2000 nm.

The heat resistance (e.g., thermal deformation temperature or thermal decomposition temperature) of the binder polymer for light-to-heat conversion layer is preferably higher than that of the material used for the layer to be provided on the light-to-heat conversion layer.

Heat-Sensitive Peelable Layer

A heat-sensitive peelable layer may be provided on the light-to-heat conversion layer of the thermal transfer sheet. The heat-sensitive peelable layer includes a heat-sensitive material which generates a gas or releases adhered water or the like by the action of heat generated in the light-to-heat conversion layer, and thus weakens the strength of adhesion between the light-to-heat conversion layer and the thermal transfer layer.

Examples of the heat-sensitive material include a compound (a polymer or a compound having a low molecular weight) which itself decomposes or degenerates due to the action of heat to thereby generate a gas; and a compound (a polymer or a compound having a low molecular weight) which contains, by way of absorption or adsorption, a considerable amount of an easily vaporizable liquid such as water. These compounds may be used in combination.

Examples of the polymer which decomposes or degenerates due to heat and thereby generates a gas include an auto-oxidizable polymer such as nitrocellulose; a halogen-containing polymer such as chlorinated polyolefin, chlorinated rubber, polychlorinated rubber, polyvinyl chloride, polyvinylidene chloride, or the like; an acrylic polymer such as polyisobutyl methacrylate, in which a volatile compound such as water is adsorbed; a cellulose ester such as ethyl cellulose, in which a volatile compound such as water is adsorbed; and a natural high polymeric compound such as gelatin, in which a volatile compound such as water is adsorbed. Examples of the compound which has a low molecular weight and which decomposes or degenerates due to heat to thereby generate a gas, include a compound such as a diazo compound or an azide compound which decomposes due to heat and thereby generates a gas. Such decomposition or degeneration of the heat-sensitive material due to heat as described above preferably occurs at 280° C. or below, and particularly preferably at 230° C. or below.

In a case in which a compound having a low molecular weight is used as the heat-sensitive material of the heat-sensitive peelable layer, it is preferable that the low molecular weight compound is used in combination with a binder. Examples of such a binder include a polymer which itself decomposes or degenerates due to heat and thereby generates a gas, and an ordinary polymeric binder not having the characteristic of decomposing or degenerating due to heat to thereby generate a gas.

In a case in which the heat-sensitive compound having a low molecular weight and the binder are used in combination, the weight ratio of the former to the latter is preferably in a range of 0.02:1 to 3:1, and more preferably in a range of 0.05:1 to 2:1.

Preferably, the heat-sensitive peelable layer covers substantially the entire surface of the light-to-heat conversion layer. The thickness of the heat-sensitive peelable layer is generally in a range of 0.03 to 1 μm, and preferably in a range of 0.05 to 0.5 μm.

In a case in which the thermal transfer sheet is structured such that the light-to-heat conversion layer, the heat-sensitive peelable layer, and the thermal transfer layer are laminated to one another in that order and are provided on a substrate, the heat-sensitive peelable layer decomposes or degenerates to thereby generate a gas due to heat transmitted from the light-to-heat conversion layer. Then, due to this decomposition or generation of a gas, a portion of the heat-sensitive peelable layer disappears or the adhesive strength by which the light-to-heat conversion layer and the thermal transfer layer are held in contact with each other deteriorates as the result of aggregational disruption that occurs in the heat-sensitive peelable layer. Because of this behavior of the heat-sensitive peelable layer, a portion of the heat-sensitive peelable layer may undesirably adhere to the thermal transfer layer, and that portion may appear on the surface of the resulting image, thus causing color mixing of the image.

Thus, it is desirable that the heat-sensitive peelable layer is substantially non-colored (i.e., it is desirable that the heat-sensitive peelable layer exhibits high permeability with respect to visible light) to prevent visibly apparent color mixing in the image which has been formed even when such image transfer as described above of the heat-sensitive peelable layer is performed. More specifically, a light absorptance of the heat-sensitive peelable layer with respect to visible light is preferably 50% or less, and more preferably 10% or less.

Instead of providing a heat-sensitive peelable layer separately, the light-to-heat conversion layer may be used as the heat-sensitive peelable layer by adding a heat-sensitive material to the light-to-heat conversion layer.

Substrate

The material for the substrate is not particularly limited, and various materials can be suitably selected in accordance with the object. Preferred examples of the substrate material include synthetic materials such as polyethylene terephthalate, polyethylene-2,6-naphthalate, polycarbonate, polyethylene, polyvinyl chloride, polyvinylidene chloride, polystyrene, and styrene/acrylonitrile copolymers. Among these materials, biaxially stretched polyethylene terephthalate is preferable from the standpoint of mechanical strength and dimensional stability with respect to heat. The substrate of the thermal transfer sheet is preferably formed by a transparent, laser light-transmitting synthetic material, in a case in which the thermal transfer sheet is used for preparation of a color proof by utilizing laser light for image recording.

In order to improve the contact between the substrate of the thermal transfer sheet and the light-to-heat conversion layer to be provided on the substrate, a surface activation treatment of the substrate may be carried out and/or one or more primer layers may be formed on the substrate.

Examples of the surface activation treatment include a glow discharge treatment and a corona discharge treatment.

Materials for the primer layer are preferably materials which exhibit excellent adhesive property to the surfaces of both the substrate and the light-to-heat conversion layer, and which have low thermal conductivity and excellent heat resistance. Examples of such materials for the primer layer include styrene, a styrene/butadiene copolymer, gelatin and the like. The total thickness of the primer layer is generally in a range of 0.01 to 2 μm.

In addition, various functional layers, such as an anti-reflection layer and the like, may be provided on the surface of the substrate at the side opposite to the side on which the light-to-heat conversion layer is provided, or surface treatment may be carried out as needed.

The surface of the thermal transfer layer preferably has surface physical properties such that a smoothster value is 4 mmHg or less, and a center line average surface roughness (Ra value) is 0.04 to 0.3 μm.

When the smoothster value exceeds 4 mmHg and the center line average surface roughness (Ra value) exceeds 0.3 μm, the quality of image may deteriorate. When the center line average surface roughness is less than 0.04 μm, the manufacturing cost of the layer may increase.

The Ra value can be measured by using a surface roughness measuring device (e.g., SURFCOM manufactured by Tokyo Seiki Co., Ltd.) or the like.

The smoothster value represents the surface smoothness of the layer. The value is measured by using a diffusive semiconductor pressure transducer and is expressed as the change in pressure which is caused by a change in the amount of airflow due to the degree of surface smoothness. The smaller the smoothster value, the higher the surface smoothness. That is, if the uneven portions on the surface are small, or else are few, the amount of airflow between the gaps of these uneven portions is also small. Specifically, smoothness can be measured as below.

A pipe having a vacuum pump therein and having an object head having an area of a¹ at one end of the pipe, and a throttle portion having an area of a² between the object head and the vacuum pump is prepared. The object head is made to contact the surface to be measured (for example, the surface of a image forming layer), and air is sucked into the pipe by using the vacuum pump. Pressure P inside the pipe between the throttle portion and the object head varies in accordance with an area ratio of a¹ to a², and can be expressed by the following equation. a² varies in accordance with the object to be measured, and pressure P represents the surface smoothness of the object to be measured.

P=(a²/a¹)Pz [Pz: atmospheric pressure]

The measuring device for measuring the surface smoothness may be, for example, a smoothness tester (DIGITAL SMOOTHSTER manufactured by Toei Electronics Co., Ltd.).

As described above, a deterioration in the pigment dispersibility due to precipitation of the inorganic or metal pigment in the coating solution during the manufacturing process can be suppressed by utilizing the precipitation inhibitor in the coating solution for forming the thermal transfer layer, so that the thermal transfer sheet of the present invention having a thermal transfer layer in which the inorganic or metal pigment is dispersed uniformly can be achieved stably and at a low cost. By using this thermal transfer sheet, an image (color proof) with a high degree of metallic gloss or whiteness and a uniform color tone can be formed. Moreover, since the image is formed by laser irradiation, an image with extremely high definition and high quality can be formed.

Image Receiving Sheet

The image receiving sheet can be structured in any form as long as it retains an image from the thermal transfer sheet of the present invention by a thermal transfer process. For example, the image receiving sheet can be formed such that on a substrate, which is provided separately from that of the thermal transfer sheet, at least an image receiving layer is provided, and other layers such as a primer layer, a cushion layer, a peelable layer, and an intermediate layer may be provided between the substrate and the image receiving layer as needed. Further, a backing layer may preferably be provided at a side opposite to the side at which the image receiving layer is provided, from the standpoint of conveyance, storability, and capability of roughening the surface of the image receiving layer for cases when the image receiving sheet is taken-up in a roll. Further, providing an antistatic layer separately from these layers or adding an antistatic agent to each of the above-described layers is also preferable. The image receiving sheet can be used not only for the thermal transfer sheet of the present invention, but also for a thermal transfer sheet having a non-glossy thermal transfer layer (occasionally referred to as “a thermal transfer sheet for forming a non-glossy image”, hereinafter), which does not include an inorganic or metal pigment as the color material.

Image Receiving Layer

The image receiving layer is a layer which is formed with an organic polymer binder as a main component.

The organic polymer binder (occasionally referred to as “binder polymer for the image receiving layer”, hereinafter) is preferably a thermoplastic resin. Examples of the resin include homopolymers or copolymers of acrylic monomers such as acrylic acid, methacrylic acid, acrylates, and methacrylates; cellulose polymers such as methyl cellulose, ethyl cellulose, and cellulose acetate; vinyl homopolymers and copolymers of vinyl monomers such as polystyrene, polyvinyl pyrrolidone, polyvinyl butyral, polyvinyl alcohol, and polyvinyl chloride; condensation polymers such as polyesters and polyamides; and rubber polymers such as butadiene/styrene copolymers.

From the standpoint of obtaining an appropriate strength of adhesion between the image receiving layer and the thermal transfer layer, a glass transition temperature (Tg) of the binder polymer for the image receiving layer is preferably less than 90° C. A plasticizer may be added to the image receiving layer for that purpose. Further, the Tg of the binder polymer for the image receiving layer is preferably 30° C. or more in order to prevent blocking between sheets.

From the standpoints of improving adhesion between the image receiving layer and the thermal transfer layer (or the non-glossy thermal transfer layer) of the thermal transfer sheet, and of improving sensitivity or image stability during image recording by laser irradiation, a polymer, which is the same as or similar to the binder polymer for the thermal transfer layer (or the non-glossy thermal transfer layer) is preferably used as the binder polymer for the image receiving layer.

The surface of the image receiving layer of the image receiving sheet preferably has surface physical properties such that a smoothster value is 4 mmHg or less, and a center line average surface roughness (Ra value) is 0.04 to 0.3 μm. As described above, since metallic glossy pigments and the like have a large particle diameter, the surface of the metallic glossy thermal transfer layer tends to be roughened easily. In order to compensate for this tendency of the surface to become rough, high planarity of the image receiving surface of the image receiving sheet is necessary.

When the smoothster value exceeds 5 mmHg and the center line average surface roughness (Ra value) exceeds 0.3 μm, the image quality may deteriorate. When the center line average surface roughness is less than 0.04 μm, a special surface smoothing process is required, so that the manufacturing cost of the layer may increase.

The Ra values and the smoothster values can be measured in the same manner as those for the thermal transfer sheet.

The thickness of the image receiving layer preferably ranges from 0.3 to 7 μm, and more preferably from 0.7 to 4 μm.

If the thickness of the image receiving layer is less than 0.3 μm, the film strength is insufficient and the image receiving layer is liable to be broken when an image is transferred (printed) onto printing paper. If the thickness exceeds 7 μm, the gloss of the image may increase after the image has been printed on printing paper, such that reproducibility of the original image deteriorates.

Examples of the plasticizer which can be used for the image receiving layer are the same plasticizers as those which can be used for the thermal transfer layer of the thermal transfer sheet.

Substrate

Generally, examples of a substrate which can be used for the image receiving sheet are a base material in the form of a sheet such as a plastic sheet, a paper, a metal sheet, a glass sheet, or the like.

Examples of the plastic sheet include a polyethylene terephthalate sheet, a polyethylene naphthalate sheet, a polyethylene sheet, a polycarbonate sheet, a polyvinyl chloride sheet, a polyvinylidene chloride sheet, and a polystyrene sheet. Among these sheets, a polyethylene terephthalate sheet is particularly preferable.

Examples of the paper include printing paper and coated paper.

Further, from the standpoint of cushioning characteristics, image visibility, and the like, a white material having foam inside is preferably used as a substrate. In particular, from the standpoint of mechanical properties, use of a foamed polyester substrate is most preferable. In order to improve adhesion between the image receiving layer and the substrate, the surface of the substrate can be treated by a corona discharging treatment or a glow discharging treatment.

The thickness of the substrate is generally in a range of 10 to 400 μm, and particularly preferably in a range of 25 to 200 μm.

Backing Layer

In order to improve surface roughening of the surface of the image receiving layer or conveying performance inside an image recording device, additives such as antistatic agents formed, for example, of silicon dioxide fine particles, surfactants or tin oxide fine particles may be added to the backing layer.

These additives can be added not only to the backing layer but also to the image receiving layer and/or other layers if necessary.

Examples of the fine particles include inorganic fine particles such as silicon dioxide, calcium carbonate, titanium dioxide, aluminum oxide, zinc oxide, barium sulfate, and zinc sulfate; and organic fine particles formed by resins such as a polyethylene resin, a silicone resin, a fluorine containing resin, an acrylic resin, a methacrylic resin, and a melamine resin. Among these, titanium dioxide, calcium carbonate, silicon dioxide, a silicone resin, an acrylic resin, and a methacrylic resin are particularly preferable.

The mean particle diameter of the fine particles is preferably in a range of 0.5 to 10 μm and more preferably in a range of 0.8 to 5 μm.

The content of fine particles with respect to the total solid weight of the backing layer or the image receiving layer, is preferably in a range of 0.5 to 80% by weight, and more preferably in a range of 1 to 20% by weight.

The antistatic agent can be appropriately selected from various surfactants and electrically conductive agents such that the surface resistance of the backing layer is preferably 10¹² Ω or less, and more preferably 10⁹ Ω or less under environmental conditions of 23° C. and 50% RH.

As described above, two aspects have been presented as examples of the image receiving sheet: aspect (1) in which the sheet has the image receiving layer on the substrate, and aspect (2) in which the sheet has the image receiving layer on one surface of the substrate and the backing layer containing fine particles on the other surface thereof. However, the present invention is not limited to these two aspects, and the following aspects are also possible. Namely, the present invention can be exemplified by an aspect (3) in which the image receiving sheet has a cushion layer provided between the substrate of (2) and the image receiving layer, or by an aspect (4) in which the sheet further contains in the image receiving layer of aspect (3), fine particles similar to those which have been used for the backing layer.

In the case of the above-described aspects (2) to (4), by taking up the image receiving sheet in a roll, the surface of the image receiving layer can be roughened due to pressure exerted by the backing layer containing fine particles.

In the same manner as in the aspects (3) and (4), by providing the cushion layer as the intermediate layer under the image receiving layer, insufficient contact between the image receiving layer and the thermal transfer layer due to roughening of the surface of the image receiving layer can be prevented, and this cushion layer can be suitably applied to the present invention as well.

Cushion Layer

In order to prevent unsatisfactory contact between the layers due to surface roughening of the surface of the image receiving layer, it is preferable to provide the cushion layer between the substrate and the image receiving layer of the image receiving sheet as described above.

The cushion layer is a layer which deforms when stress is applied to the image receiving layer, and has the effects of improving the close fit between the thermal transfer layer and the image receiving layer during the laser thermal transfer process, and of improving image quality as well. Further, during image recording, even if foreign matter enters between the thermal transfer sheet and the image receiving sheet, due to the deformation of the cushion layer, air gaps formed between the image receiving layer and the thermal transfer layer are reduced in size. As a result, the cushion layer can minimize size of defective image portions such as undyed portions (portions which are left white). Further, when the image which has been transferred onto the image receiving layer is then printed (transferred) onto printing paper or the like which is readied separately, the image receiving surface can be deformed in accordance with the convexities and concavities of the surface of the printing paper. Therefore, due to the effect of the cushion layer, the transfer performance of the image receiving layer can be improved. Further, due to the effect of the cushion layer, the gloss of images to be transferred can be decreased or controlled, and therefore reproducibility of the original image can be improved.

In order to provide the cushion layer with cushioning characteristics, a material having a low modulus of elasticity, a material having a rubber elasticity, or a thermoplastic resin which easily softens when heated can be used.

The modulus of elasticity is preferably in a range of 10 to 500 kgf/cm², and more preferably in a range of 30 to 150 kgf/cm² at room temperature.

In order to infiltrate foreign matter such as rubber or the like into the cushion layer, penetration of the cushion layer under the conditions of 25° C., 100 g, and 5 seconds is preferably 10 or more.

The glass transition temperature of the cushion layer is 80° C. or less, and preferably 25° C. or less. In order to control physical properties such as Tg, addition of a plasticizer to the polymer binder can be suitably carried out.

Examples of binders for forming the cushion layer include rubbers such as urethane rubber, butadiene rubber, nitrile rubber, acrylic rubber, natural rubber, and the like, as well as polyethylene, polypropylene, polyester, a styrene/butadiene copolymer, an ethylene/vinyl acetate copolymer, an ethylene/acrylic copolymer, a vinyl chloride/vinyl acetate copolymer, a vinylidene chloride resin, a plasticizer-containing vinyl chloride resin, a polyamide resin, a phenol resin, and the like.

The thickness of the cushion layer depends on the type of resin or other conditions, but generally, the thickness of the cushion layer preferably ranges from 3 to 100 μm, and more preferably ranges from 10 to 50 μm.

It is necessary for the image receiving layer and the cushion layer to be set in close contact with each other by the laser recording stage. However, in order to print (transfer) an image on the printing paper, the image receiving layer and the cushion layer are preferably provided so as to be peelable from each other. In order to facilitate this peeling-off, it is also preferable to provide a peelable layer having a thickness of about 0.1 to 2 μm between the cushion layer and the image receiving layer.

This peelable layer preferably functions as a barrier for the coating solvent when the image receiving layer is applied.

An example of an image receiving sheet having the laminated structure of the substrate/cushion layer/image receiving layer has been described. However, in some cases, since the image receiving layer is used as the cushion layer, the image receiving sheet can be formed as the laminated structure of the substrate/cushioning image receiving layer such that the image receiving layer also serves as the cushion layer, or the substrate/primer layer/cushioning image receiving layer with the image receiving layer also serving as the cushion layer. Even in these cases, in order to enable printing (transferring) of images onto printing paper, it is preferable to provide the cushioning image receiving layer to be peelable from the sheet.

The thickness of the image receiving layer which is also used as the cushion layer preferably ranges from 5 to 100 μm, and more preferably ranges from 10 to 40 μm.

When the image which has been formed on the image receiving layer is then printed on the printing paper, preferably, at least one of the image receiving layers is formed by a light-curing material.

Examples of compositions of such a light-curing material include a combination of a) a photopolymerizable monomer formed by at least one of a polyfunctional vinyl compound and a polyfunctional vinylidene compound which can form a photopolymer by addition polymerization, b) an organic polymer, and c) a photopolymerization initiator, and additives such as a thermal photopolymerization inhibitor if necessary.

Examples of the polyfunctional vinyl monomer include unsaturated esters of polyol, and esters of acrylic acid or methacrylic acid in particular (e.g., ethyleneglycol diacrylate, pentaerythritol tetraacrylate).

Examples of the organic polymer are the same compositions as those listed as examples of the binder polymer for the image receiving layer.

Examples of the photopolymerization initiator include ordinary radical photopolymerization initiators such as benzophenone and Michler's ketone. The photopolymerization initiator can be used in an amount of 0.1 to 20% by weight based on the weight of the total solids in the layer.

Intermediate Layer

In preparing the cushion layer, in order to prevent fine particles, which are contained in the surface-roughened backing layer or the image receiving layer, from precipitating, it is preferable to provide an intermediate layer.

Since the intermediate layer is used for such a purpose as described above, this layer does not deform easily in response to applied stress. Further, materials which are applicable to the cushion layer must be used for the intermediate layer, and this layer can be formed by using polymers whose glass transition temperature is relatively high, such as PMMA, polystyrene, or cellulose triacetate.

In a case in which an image is formed by using the thermal transfer sheet of the present invention and the image receiving sheet, a thermal transfer sheet having a non-glossy thermal transfer layer (a thermal transfer sheet for forming a non-glossy image), which contains non-glossy coloring agents of Y, M, C, and K but does not contain an inorganic or metal pigment as the color material, may also be used in combination.

The thermal transfer sheet for forming a non-glossy image can be prepared in the same manner as the thermal transfer sheet of the present invention except that non-glossy coloring agents are used instead of the inorganic or metal pigments as the color materials. Moreover, it is effective to use a precipitation inhibitor having the above-described thixotropic properties in a case in which the color materials are pigments having a large particle diameter and a high specific gravity.

Method of Thermal Transfer Recording

Examples of methods of thermal transfer recording for recording images using the thermal transfer sheet of the present invention (occasionally referred to as a “thermal transfer sheet for forming a metallic glossy image”, hereinafter), which has the thermal transfer layer containing a metallic glossy pigment therein, will be described hereinafter. In this case, the thermal transfer sheet for forming a non-glossy image can be used in combination, as described above, with the thermal transfer sheet for forming a metallic glossy image.

Examples of the method of thermal transfer recording include a method of thermal transfer recording using a heating device such as a thermal head or an electrically conductive head, a method of laser thermal transfer recording in which a laser controlled by electric signals is irradiated imagewise, and the like.

The method of thermal transfer recording using a heating device such as a thermal head is used in a case in which the thermal transfer sheet for forming a metallic glossy image, in which a light-to-heat conversion layer is not provided, is used. In this method, a laminate is prepared by laminating the thermal transfer sheet and the image receiving sheet so as to set the image receiving layer of the image receiving sheet and the surface of the thermal transfer layer of the thermal transfer sheet in tight contact with each other. Heat is applied imagewise to the surface of the thermal transfer sheet for forming a metallic glossy image of the laminate from the top of the thermal transfer sheet of the laminate (i.e., from a surface of the substrate at the side opposite to the side having the thermal transfer layer), by controlling heater elements of a thermal head or the like. Thereafter, the image receiving sheet and the thermal transfer sheet for forming a metallic glossy image are peeled off from each other. As a result, the entire thermal transfer layer at the heated region, i.e., portions of the thermal transfer layer with a certain thickness which are disposed in the heated region, are peeled off from the substrate or the like of the thermal transfer sheet for forming a metallic glossy image at the contacting surface thereof, thereby enabling formation of an image with a high and uniform degree of metallic gloss on the image receiving sheet.

This method is advantageous from the standpoint of simplification of the device.

The method of laser thermal transfer recording is used in a case in which the thermal transfer sheet for forming a metallic glossy image in which the light-to-heat conversion layer is provided is used. In the method of laser thermal transfer recording, a laminate is prepared, in the same manner as in the method of thermal transfer recording using a heating device, by laminating the thermal transfer sheet for forming a metallic glossy image and the image receiving sheet so as to set the image receiving layer of the image receiving sheet and the surface of the thermal transfer layer of the thermal transfer sheet in tight contact with each other. The surface of the thermal transfer sheet of the laminate is irradiated imagewise with a laser light in time series from the top of the thermal transfer sheet of the laminate (i.e., from the substrate surface of the thermal transfer sheet). Thereafter, the image receiving sheet and the thermal transfer sheet for forming a metallic glossy image are peeled off from each other. As a result, the region heated by the light-to-heat conversion operation of the entire thermal transfer layer (the region subjected to laser light irradiation), that is, the portions of the thermal transfer layer with a certain thickness disposed in the heated region, are peeled off from the light-to-heat conversion layer of the thermal transfer sheet at the contacting surface thereof, thereby enabling formation of an image having a high and uniform degree of metallic gloss on the image receiving sheet.

There are a number of examples of methods for forming the laminate described above. For example, a vacuum contact method can be used to set the layers in contact with each other from the standpoint that temperature control of a heat roller or the like is unnecessary, and rapid and uniform lamination is possible.

In this case, in decreasing the surface roughness of the layer in order to improve adhesion between the thermal transfer sheet and the image receiving sheet, it becomes impossible to carry out high speed pressure reduction during vacuum-suctioning. On the contrary, in increasing the surface roughness of the layer in order to carry out the vacuum-suctioning more rapidly, the degree of pressure reduction at the surface between the image receiving layer of the image receiving sheet and the thermal transfer layer of the thermal transfer sheet for forming a metallic glossy image which are in contact improves. However, many microscopic air gaps form at this contact surface, which may result in a deterioration in transferability.

In order to obtain appropriate adhesion for image recording, it is preferable that the surface of the layer at the contact surface has a configuration which varies in accordance with the increase of the degree of pressure reduction at the contact surface. In this way, the image receiving layer and the thermal transfer layer can be made to contact with each other fully and uniformly. Therefore, it is advantageous to provide the cushion layer on the thermal transfer sheet for forming a metallic glossy image and/or on the image receiving sheet from the standpoint of improving the transferability and of forming an image of high quality.

In addition to the vacuum contact method, methods of forming a laminate may preferably be, for example, a method in which an image transfer side (i.e., a thermal transfer layer side) of the thermal transfer sheet and an image receiving side (i.e., an image receiving layer side) of the image receiving sheet are superimposed to thereby form a laminate, and the resultant laminate is passed through pressurizing rollers or heating rollers. In this case, the heating temperature is preferably 160° C. or less, and more preferably in a range of 50 to 130° C. Further, the method of forming a laminate may preferably be, for example, a method in which an image receiving sheet and a thermal transfer sheet are kept in close contact with each other by the image receiving sheet being mechanically adhered around a metal drum while being pulled taut, and the thermal transfer sheet also being mechanically adhered thereon while being pulled taut in the same manner as the image receiving sheet. Among these examples, the vacuum contact method is particularly preferable.

The thermal transfer sheet may be made to closely contact the image receiving layer immediately before the laser light irradiation operation.

Generally, when the vacuum contact method is used, the image receiving sheet side of the laminate is set in tight contact with the surface of a recording drum (i.e., a rotating drum having therein a vacuum-forming mechanism and also having a large number of fine openings formed in the surface of the drum) due to vacuum-suctioning. Then, the thermal transfer sheet for forming a metallic glossy image (or the thermal transfer sheet for forming a non-glossy image) having a larger size than the image receiving sheet is set in close contact with the image receiving sheet such that the entire image receiving sheet is covered by the thermal transfer sheet while pressure reduction due to vacuum-suction is carried out at the contact surfaces therebetween. In this state, the laser light irradiation operation is carried out such that the laminate is irradiated with laser light from the outside thereof. That is, irradiation is carried out from above the laminate thereof at the thermal transfer sheet side thereof. The irradiation of the laser light is such that the recording drum is scanned by being irradiated with the laser light which moves back and forth in a widthwise direction of the drum. During the irradiation operation, the recording drum is made to rotate at a fixed speed.

The method of laser thermal transfer recording can be applied not only to formation of a metallic glossy image of a single color, but can also be favorably used for formation of a multicolor image. A multicolor image can be formed by, for example, a method having one of the following aspects (first and second aspects). In this case, the thermal transfer sheet for forming a metallic glossy image and the thermal transfer sheet for forming a non-glossy image can be used in combination.

In the first aspect, the following steps are carried out. Firstly, an image receiving sheet is fixed on a rotating drum of a recording device by the vacuum reduced pressure method, and a thermal transfer sheet for forming a metallic glossy image is laminated on the image receiving sheet by the vacuum reduced pressure method in the same manner such that an image receiving layer of the image receiving sheet and a thermal transfer layer (hue 1) of the thermal transfer sheet contact each other. Next, laser light modulated on the basis of digital signals of a color-separated image of the original image is irradiated from the substrate side of the thermal transfer sheet while the drum is rotated. Thereafter, the thermal transfer sheet is peeled off from the image receiving sheet in a state in which the image receiving sheet is fixed on the drum. On the image receiving sheet on which the image having metallic gloss of hue 1 has been recorded, thermal transfer sheets for forming a metallic glossy image or thermal transfer sheets for forming a non-glossy image of hues 2 and 3, and if necessary, 4, are laminated and subjected to laser recording, and are then peeled off by the same method as that described above, consecutively. In this way, an image receiving sheet on which a multicolor metallic image has been formed can be obtained.

In order to obtain a color proof image on a printing paper, the following steps are carried out. The image receiving sheet on which a multicolor image has been formed by the above-described steps is laminated such that the image surface thereof contacts a printing paper. Then, the image receiving sheet and the printing paper are passed through a laminator or the like, heated and pressed, and the image receiving sheet is peeled off from the printing paper so that the image is transferred to the printing paper together with the image receiving layer.

In the second aspect, the following steps are carried out. A laminate is prepared by laminating a thermal transfer sheet for forming a metallic glossy image or a thermal transfer sheet for forming a non-glossy image with an image receiving sheet. In the case of a three-color image, for example, three laminates need to be prepared, and in the case of a four-color image, four laminates need to be prepared. Laser light is irradiated on each of the laminates on the basis of digital signals of the color image corresponding to the laminate, which color image is obtained via a color separation filter. Thereafter, the thermal transfer sheet is peeled off from the image receiving sheet in each laminate. Color-separated images of respective colors are independently formed on the respective image receiving sheets, and thereafter, each of the color-separated images is successively transferred onto the actual substrate, such as a separately prepared printing paper or the like or a similar substrate, so that the image is formed.

Examples of laser light sources for the image recording process include direct laser lights including a gas laser such as an argon ion laser, a helium/neon laser, a helium/cadmium laser and the like, a solid-state laser such as a YAG laser light and the like, a semiconductor laser, a dye laser, a excimer laser, and the like. Alternatively, a laser light, which is generated by halving the wavelength of the above-mentioned laser lights through a secondary harmonic element, can also be used. Among these examples, from the standpoints of high power and high speed image forming capability, use of a multi-mode semiconductor laser is preferable, and use of a refractive index guided lateral multi-mode semiconductor laser is particularly preferable.

In the method of laser thermal transfer recording using the thermal transfer sheet of the present invention, it is preferable to irradiate a laser light such that the beam diameter on the light-to-heat conversion layer is 3 to 50 μm, and preferably 7 to 30 μm.

Although metallic glossy pigments have been explained for illustrative purposes as an example of the inorganic or metal pigment, the above descriptions can be equally applied to inorganic white pigments such as titanium oxide and the like.

### EXAMPLES

The present invention will be described with reference to the following Examples. However, the present invention is not limited to these Examples. Further, “parts” and “%” in the Examples denote “parts by weight” and “% by weight”, respectively.

### Example 1

### <Preparation of Thermal Transfer Sheet>

1) Preparation of Coating Solution for Metallic Glossy Thermal Transfer Layer

A polymer binder, a precipitation inhibitor, and a wetting dispersant of the following composition were dissolved in a solvent by using a stirrer. A mica pigment was then added to the mixture, and dispersed by an ultrasonic disperser. Additional solvent was added to the resultant dispersion to thereby obtain a coating solution for metallic glossy thermal transfer layer (1) having the following composition.

[Composition of Coating Solution for Metallic Glossy Thermal Transfer Layer (1)]

Polyvinyl butyral

65 parts

(trade name: DENKA BUTYRAL #2000-L; having a Vicat softening point of 57° C. manufactured by Denki Kagaku Kogyo Co., Ltd.)

Mica pigment

30 parts

(titanium dioxide covered pearl pigment, trade name: IRIODIN 123, manufactured by Merck Japan Ltd., particle size: 5 to 25 μm, particle thickness: 0.2 to 0.5 μm)

High molecular polycarbonate long chain amine salt

0.4 parts

(wetting dispersant, trade name: DISPARON #1831, manufactured by Kusumoto Kasei Co., Ltd.)

Fatty acid amide

9 parts

(precipitation inhibitor 1, trade name: DISPARON 6900-20X, manufactured by Kusumoto Kasei Co., Ltd., solid content: 20%)

Polyethylene oxide

26 parts

(precipitation inhibitor 2, trade name: DISPARON 4200-10, manufactured by Kusumoto Kasei Co., Ltd., solid content: 10%)

n-propyl alcohol

550 parts

2) Preparation of Thermal Transfer Sheet Having Metallic Glossy Thermal Transfer Layer

The above coating solution for metallic glossy thermal transfer layer (1) was applied to a polyester substrate having a thickness of 4.5 μm over one minute by using a spin coater, and the coated substrate was dried for two minutes in an oven at 100° C. to thereby form a thermal transfer sheet (1) of the present invention having a metallic glossy thermal transfer layer thereon.

When the cross section of the thermal transfer layer was observed by using a scanning electron microscope, the average thickness thereof was found to be 0.7 μm, and it was observed that the flat surface side of the mica pigment was disposed substantially parallel to the substrate. Further, the hue of the thermal transfer layer was silver, and when the glossiness thereof was measured, it was found to be 2.7.

A spectrophotometric calorimeter for measuring glossiness (trade name: CM-512m3, manufactured by Minolta Co., Ltd.) was utilized to measure the glossiness. Xenon pulse light was irradiated on a sample surface from directions at angles of 25° and 75° from the vertical axis direction of the sample surface. A photoreceptive sensor provided in a direction at an angle of 45° from the vertical axis received reflected light and spectrophotometric colorimetry was carried out on the reflected light to obtain the L* value thereof. Thereafter, the ratio of the L* value at incidence of 25° and that at incidence of 75° (L*(25°)/L*(75°)) was determined.

3) Preparation of Coating Solution for Non-Metallic Glossy Thermal Transfer Layer

(Coating Solution for Yellow Thermal Transfer Layer)

Compounds of the following composition were mixed to prepare a yellow pigment dispersed mother liquor.

[Composition of Yellow Pigment Dispersed Mother Liquor]

Polyvinyl butyral

12 parts

(trade name: DENKA BUTYRAL #2000-L; having a Vicat softening point of 57° C. manufactured by Denki Kagaku Kogyo Co., Ltd.)

Yellow pigment (C.I.P.Y. 14)

12 parts

Wetting dispersant

0.8 parts

(trade name: SOLSPERSE S-20000, manufactured by ICI Japan Ltd.)

n-propyl alcohol

110 parts

To the mother liquor, 100 g of glass beads were added and dispersed by a paint shaker for two hours. The respective components of the following composition were mixed in with the resultant dispersion while stirring was carried out by the stirrer, to prepare the coating solution for yellow thermal transfer layer.

[Composition of Coating Solution for Yellow Thermal Transfer Layer]

Yellow pigment dispersed mother liquor

20 parts

n-propyl alcohol

60 parts

Stearic acid amide

0.5 parts

Surfactant

0.05 parts

(trade name: MEGAFAC F-176PF, manufactured by Dainippon Ink and Chemicals Inc.)

(Coating Solutions for Magenta, Cyan, and Black Thermal Transfer Layers)

A coating solution for magenta thermal transfer layer, a coating solution for cyan thermal transfer layer, and a coating solution for black thermal transfer layer were prepared in the same manner as the coating solution for yellow thermal transfer layer except that the yellow pigment used for the preparation of the yellow pigment dispersed mother liquor was replaced by C.I.P.R. 57:1 as a magenta pigment, C.I.P.B. 15:4 as a cyan pigment, and carbon black pigment (trade name: MA-100, manufactured by Mitsubishi Chemical Corp.) as a black pigment, respectively.

4) Formation of Thermal Transfer Sheet Having a Non-Metallic Glossy Thermal Transfer Layer

A thermal transfer sheet (Y), a thermal transfer sheet (M), a thermal transfer sheet (C), and a thermal transfer sheet (K) having a non-metallic glossy thermal transfer layer of yellow, magenta, cyan, and black respectively, were formed in the same manner as the above-described thermal transfer sheet having a metallic glossy thermal transfer layer, by using the resultant coating solutions for the four color (yellow, magenta, cyan, and black) thermal transfer layers.

### <Formation of Image Receiving Sheet>

A coating solution for cushioning intermediate layer and a coating solution for image receiving layer having the following compositions were prepared.

[Composition of Coating Solution for Cushioning Intermediate Layer]

Vinyl chloride/vinyl acetate copolymer

20 parts

(trade name: MPR-TSL, manufactured by Nisshin Chemical Industry Co., Ltd.)

Plasticizer (adipic acid polyester)

10 parts

(trade name: PARAPLEX G40, manufactured by CP. HALL. Company)

Surfactant

0.5 parts

(trade name: MEGAFAC F-177, manufactured by Dainippon Ink and Chemicals Inc.)

Antistatic agent

0.3 parts

(trade name: SAT-5 SUPER (IC), manufactured by Nihon Pure-Chemical Co., Ltd.)

Solvent (methylethyl ketone)

60 parts

Toluene

10 parts

N,N-dimethyl formamide

3 parts

[Composition of Coating Solution for Image Receiving Layer]

Polyvinyl butyral

8.0 parts

(trade name: S-REC B BL-SH, manufactured by Sekisui Chemical Co., Ltd.)

Antistatic agent

0.7 parts

(trade name: SUNSTAT 2012A, manufactured by Sanyo Chemicals Industries, Ltd.)

Surfactant

0.1 parts

(trade name: MEGAFAC F-177, manufactured by Dainippon Ink and Chemicals Inc.)

n-propyl alcohol

20 parts

Methanol

20 parts

1-methoxy-2-propanol

50 parts

The coating solution for cushioning intermediate layer obtained as described above was applied to a white PET substrate (trade name: LE MIRROR E-68L, having thickness of 135 μm, manufactured by Toray Industries Inc.) by using a small width application device, and the coating solution was then dried so as to have a layer thickness of about 20 μm after drying. Then, the coating solution for image receiving layer was applied onto the cushioning intermediate layer, and then dried so as to have a layer thickness of about 2 μm after drying. Thereafter, the resultant image receiving sheet was wound up in a roll form, and was kept for a week at room temperature and then used for evaluation.

The surface roughness (center line average surface roughness) Ra value of the surfaces of each of the thermal transfer layers of the thermal transfer sheet (1) of the present invention and the thermal transfer sheets (Y), (M), (C), and (K) was 0.08 μm. Further, the Ra value of the surface of the image receiving layer of the image receiving sheet was 0.13 μm, and a smoothster value thereof was 0.7 mmHg or less.

The Ra values were measured by using a surface roughness measuring device manufactured by Tokyo Seimitsu Co., Ltd. under the following conditions: the axial magnification was 2,000, the roughness cut-off value was 0.08 mm, the reference length was 2.5 mm, and the conveying speed was 0.1 mm/second. The smoothster values were measured by using an air permeability and smoothness measuring device (DIGITAL SMOOTHSTER) manufactured by Toei Electronics Co., Ltd.

The waviness of the surface of each of the thermal transfer layers of the thermal transfer sheet (1) of the present invention and the thermal transfer sheets (Y), (M), (C), and (K) and of the image receiving layer of the image receiving sheet obtained as described above (wherein the waviness was measured by the surface roughness measuring device manufactured by Tokyo Seimitsu Co., Ltd. under the following measurement conditions: axial magnification: 2,000, roughness cut-off value: 8 mm, reference length: 5 mm, and conveying speed: 0.15 mm/sec.) was less than or equal to 2 μm. Similarly, the waviness of the surface of each of the thermal transfer layers formed in Examples shown below was less than or equal to 2 μm.

Image Forming

First, the thermal transfer sheet (1) of the present invention, which has the metallic glossy thermal transfer layer, and the image receiving sheet were laminated, and a heat-sensitive printing process was performed by a thermal head recording device (the thermal head thereof being modulated by image signals corresponding to images with gold color gloss) using a sub-scan separation method. The principle of this method is such that heads having a size of 75 μm×50 μm are turned on and off at a minute sending pitch of 3 μm in the direction of the smaller edge (50 μm) side of the head to thereby carry out a multi-step recording with area gradations.

Then, the polyester substrate of the thermal transfer sheet (1) was peeled off from the image receiving sheet to thereby form a glossy image with a metallic tone (i.e., a metallic glossy image), which was formed with area gradations, on the image receiving sheet. The color tone of the image at this time was silver.

Thereafter, on the image receiving sheet on which the metallic glossy image had been formed, black, cyan, magenta, and yellow, in this order, were thermally-printed with the printing process being controlled by image signals corresponding to each color. Further, the peeling-off process was performed after the printing process of the color. The printing process and peeling-off process were repeated for each color to thereby form a multi-color image.

The image receiving sheet on which a multi-color image had been formed was then laminated on art paper. The resultant laminate was passed through heat rollers, whose pressure was 4.5 kg/cm² and whose temperature was 130° C., at a conveying speed of 4 m/sec. Thereafter, the white PET film of the image receiving sheet was peeled off from the art paper so that the multi-color image on the image receiving sheet was transferred to the art paper together with the image receiving layer, thereby forming a color image.

The metallic glossy portion of the image exhibited a gold color gloss. When this portion was observed by using a magnifying lens, it was noted that the gold color was exhibited as a result of overlaying a yellow dot image, a black dot image, and a silver solid image (100% transfer), in this order, on the art paper. The image thus formed had a high degree of metallic gloss and a uniform color tone.

### Example 2

### <Formation of Thermal Transfer Sheet for Laser Recording>

1) Preparation of Coating Solution for Light-to-Heat Conversion Layer

The following components were mixed while being stirred by the stirrer to prepare a coating solution for light-to-heat conversion layer.

[Composition of Coating Solution for Light-to-Heat Conversion Layer]

Infrared light absorbing dye

10 parts

(trade name: NK-2014, manufactured by Nippon Kanko Shikiso Co., Ltd.)

Binder

200 parts

(trade name: RIKACOAT SN-20, manufactured by New Japan Chemical Co., Ltd.)

N-methyl-2-pyrrolidone

2,000 parts

Surfactant

1 part

(trade name: MEGAFAC F-177, manufactured by Dainippon Ink and Chemicals Inc.)

2) Formation of Light-to-Heat Conversion Layer on Substrate Surface

A polyethylene terephthalate film (center line average surface roughness Ra=0.04 μm) whose thickness was 100 μm was prepared as a substrate. The coating solution for light-to-heat conversion layer obtained as described above was applied to one surface of the polyethylene terephthalate film by using a rotary applicator (spin coater). Thereafter, the resultant film was dried in an oven for two minutes at the temperature of 120° C. to thereby form a light-to-heat conversion layer on the substrate.

In the wavelength range of 700 to 1,000 nm, the absorption peak of the light-to-heat conversion layer thus formed was at around 830 nm. When absorbance (optical density: OD) of the light-to-heat conversion layer was measured, it was found that the OD was equal to 1.0 (i.e., laser light absorptance: 90%). When the cross section of the light-to-heat conversion layer was observed by using a scanning electron microscope, it was found that the thickness of the layer was 0.3 μm on average.

3) Formation of Thermal Transfer Sheet Having Metallic Glossy Thermal Transfer Layer

A thermal transfer sheet (2) of the present invention having a metallic glossy thermal transfer layer exhibiting a silver gloss was formed by applying the coating solution for metallic glossy thermal transfer layer (1), which was prepared in Example 1, onto the light-to-heat conversion layer provided on the substrate, and then drying the applied coating solution, in the same manner as Example 1.

4) Formation of Thermal Transfer Sheet Having Non-Metallic Glossy Thermal Transfer Layer

The same four types of thermal transfer sheets as in Example 1 (thermal transfer sheet (Y), thermal transfer sheet (M), thermal transfer sheet (C), and thermal transfer sheet (K)) were formed by applying the coating solutions for the four color (yellow, magenta, cyan, and black) thermal transfer layers prepared in Example 1 onto a light-to-heat conversion layer, which had been provided on a separate substrate of the same type as that of the above-described thermal transfer sheet (2) having a metallic glossy thermal transfer layer exhibiting a silver gloss, in the same manner.

Image Forming

The image receiving sheet (25 cm×35 cm) formed in Example 1 was wound around a rotation drum whose diameter was 25 cm and which had vacuum suction holes of a diameter of 1 mm formed therein (at a surface density of one hole per area of 3 cm×3 cm). The image receiving sheet was then sucked to the rotation drum. Then, the black thermal transfer sheet (30 cm×40 cm) obtained as described above was laminated onto the image receiving sheet such that the black thermal transfer sheet overlapped evenly at each side of the image receiving sheet. The black thermal transfer sheet and the image receiving sheet were adhered to each other so that air was suctioned into the suction holes of the rotating drum while these sheets were squeezed by a squeeze roller. The degree of pressure reduction when the suction holes were blocked was −150 mmHg/atm.

The drum was rotated, and the surface of the laminate on the drum was irradiated from the outer side thereof by a semiconductor laser light (i.e., a multi-mode semiconductor laser whose output rating was 1 W) having a wavelength of 830 nm such that the laser light was converged onto the surface of the light-to-heat conversion layer. The laser irradiation was performed while moving the laser light in a direction (the sub-scanning direction) orthogonal to a rotating direction of the drum (the main-scanning direction), thereby laser-recording an image on the laminate. Conditions for the laser irradiation were as follows.

Laser power: 300 mW

Beam diameter: 15 μm in the main-scanning direction (Gaussian distribution), and 24 μm in the sub-scanning direction (rectangular beam)

Main-scanning rate: 5 m/sec

Sub-scanning pitch: 30 μm

Environmental temperature/humidity: 25° C., 50% RH

After completion of the laser irradiation, the substrate of the black thermal transfer sheet was removed from the drum by hand while the image receiving sheet remained fixed on the drum. In such a manner, the light-to-heat conversion layer and the thermal transfer layer were peeled apart from each other, thereby forming a black image on the image receiving sheet. Thereafter, on the black image, each of the thermal transfer sheet (C), the thermal transfer sheet (M), the thermal transfer sheet (Y), and the thermal transfer sheet (2) of the present invention exhibiting a silver gloss were laminated in that order for the laser irradiation. In the laser irradiation processes, laser lights modulated in accordance with image signals corresponding to that color were irradiated. Further, the peeling-off process was performed after the irradiation process of the color. The lamination process, the laser irradiation process, and the peeling-off process were repeated for each color to thereby form a multi-color image.

The image receiving sheet on which a multi-color image had been formed was then laminated on printing paper, and the multi-color ink image on the image receiving sheet was transferred to the printing paper together with the image receiving layer, thereby forming a color image in the same manner as Example 1.

The metallic glossy portion of the image exhibited a gold color gloss. When this portion was observed by using a magnifying lens, it was noted that the gold color was exhibited as a result of overlaying a gold-color solid image, a yellow dot image, and a black dot image, in that order, on the printing paper. The image thus formed had a high degree of metallic gloss and a uniform color tone.

### Example 3

A thermal transfer sheet (3) of the present invention was formed in the same manner as in Example 2 except that the fatty acid amide (precipitation inhibitor 1) in the coating solution for metallic glossy thermal transfer layer (1) used in Example 2 was replaced by stearic acid aluminum (i.e., a coating solution for metallic glossy thermal transfer layer (2) was prepared). Together with the thermal transfer sheet (3), the four types of thermal transfer sheets having a non-metallic glossy thermal transfer layer formed in Example 1 and an image receiving sheet were used, to thereby form a color image on printing paper in the same manner as Example 2.

The metallic glossy portion of the image exhibited a gold color gloss. When this portion was observed by using a magnifying lens, it was noted that the gold color was exhibited as a result of overlaying a silver colored solid image, a yellow dot image, and a black dot image, in that order, on the printing paper. The image thus formed had a high degree of metallic gloss and a uniform color tone.

### Example 4

A thermal transfer sheet (4) of the present invention was formed in the same manner as in Example 2 except that the mica pigment (titanium dioxide covered pearl pigment) in the coating solution for metallic glossy thermal transfer layer (1) used in Example 2 was replaced by a pearl pigment formed of bismuth oxychloride (trade name: BIRON, manufactured by Merck Japan Ltd.) (i.e., a coating solution for metallic glossy thermal transfer layer (3) was prepared). Together with the thermal transfer sheet (4), the four types of thermal transfer sheets having a non-metallic glossy thermal transfer layer formed in Example 1 and an image receiving sheet were used, to thereby form a color image on printing paper in the same manner as Example 2.

The image thus formed had a high degree of metallic gloss and a uniform color tone.

### Example 5

A thermal transfer sheet (5) of the present invention was formed in the same manner as in Example 2 except that a coating solution for metallic glossy thermal transfer layer (4) having the following components was prepared and used instead of the coating solution for metallic glossy thermal transfer layer (1) used in Example 2.

[Composition of Coating Solution for Metallic Glossy Thermal Transfer Layer (4)]

Polyvinyl butyral

65 parts

(trade name: DENKA BUTYRAL #2000-L; having a Vicat softening point of 57° C. manufactured by Denki Kagaku Kogyo Co., Ltd.)

Aluminum fine powder pigment

30 parts

(manufactured by Toyo Aluminum Co., Ltd.)

High molecular polycarbonate long chain amine salt

0.4 parts

(wetting dispersant, trade name: DISPARON #1831, manufactured by Kusumoto Kasei Co., Ltd.)

Fatty acid amide

9 parts

(precipitation inhibitor 1, trade name: DISPARON 6900-20X, manufactured by Kusumoto Kasei Co., Ltd., solid content: 20%)

Polyethylene oxide

26 parts

(precipitation inhibitor 2, trade name: DISPARON 4200-10, manufactured by Kusumoto Kasei Co., Ltd., solid content: 10%)

n-propyl alcohol

550 parts

Together with the obtained thermal transfer sheet (5), the four types of thermal transfer sheets having a non-metallic glossy thermal transfer layer formed in Example 1 and an image receiving sheet were used to thereby form a color image on art paper in the same manner as in Example 2. The metallic glossy portion of the image exhibited a gold color gloss. When this portion was observed by using a magnifying lens, it was noted that the gold color was exhibited as a result of overlaying a gold-color solid image, a yellow dot image, and a black dot image, in that order, on the art paper. The image thus formed had a high degree of metallic gloss and a uniform color tone.

### Example 6

A thermal transfer sheet (6) of the present invention was formed in the same manner as in Example 2 except that a coating solution for metallic glossy thermal transfer layer (5) having the following components was prepared and used instead of the coating solution for metallic glossy thermal transfer layer (1) used in Example 2.

[Composition of Coating Solution for Metallic Glossy Thermal Transfer Layer (5)]

Polyvinyl butyral

65 parts

(trade name: DENKA BUTYRAL #2000-L; having a Vicat softening point of 57° C. manufactured by Denki Kagaku Kogyo Co., Ltd.)

Titanium dioxide

30 parts

(anatase-type, mean particle diameter: 0.3 μm, manufactured by Ishihara Industry Co., Ltd.)

High molecular polycarbonate long chain amine salt

0.4 parts

(wetting dispersant, trade name: DISPARON #1831, manufactured by Kusumoto Kasei Co., Ltd.)

Fatty acid amide

9 parts

(precipitation inhibitor 1, trade name: DISPARON 6900-20X, manufactured by Kusumoto Kasei Co., Ltd., solid content: 20%)

Polyethylene oxide

26 parts

(precipitation inhibitor 2, trade name: DISPARON 4200-10, manufactured by Kusumoto Kasei Co., Ltd., solid content: 10%)

n-propyl alcohol

550 parts

Together with the obtained thermal transfer sheet (6), the four types of thermal transfer sheets having a non-metallic glossy thermal transfer layer formed in Example 1 and an image receiving sheet were used to thereby form a color image on art paper in the same manner as in Example 2.

The image thus formed had a high degree of whiteness in the solid image portion (dot area rate: 100%), high masking property, and a uniform color tone as well.

In accordance with the present invention, a thermal transfer sheet can be provided, which suppresses, during the manufacturing process, the deterioration of pigment dispersibility due to precipitation of an inorganic or metal pigment in a coating solution, and which has a thermal transfer layer in which the inorganic or metal pigment is dispersed uniformly, and on which an image (or color proof) having a high degree of metallic glossiness or whiteness as well as a uniform color tone can be formed.

What is claimed is:

1. A thermal transfer sheet comprising:
a substrate; and
a thermal transfer layer provided on the substrate and containing a binder, a precipitation inhibitor and an inorganic or metal pigment.

2. A thermal transfer sheet according to claim 1, wherein the precipitation inhibitor is a thixotropic agent.

3. A thermal transfer sheet according to claim 2, wherein the thixotropic agent is a fatty acid amide or polyethylene oxide.

4. A thermal transfer sheet according to claim 1, wherein the inorganic or metal pigment is a pearl pigment or a metal fine powder pigment.

5. A thermal transfer sheet according to claim 1, wherein the inorganic or metal pigment is in the form of tabular grains having a particle thickness of 0.05 to 0.7 μm and a particle size of 1 to 50 μm.

6. A thermal transfer sheet according to claim 1, wherein the inorganic pigment is a white pigment.

7. A thermal transfer sheet according to claim 6, wherein the white pigment is titanium oxide or calcium carbonate.

8. A thermal transfer sheet according to claim 1, wherein the thermal transfer layer further contains a wetting dispersant.

9. A thermal transfer sheet according to claim 1, wherein the binder is wax or a thermoplastic polymer.

10. A thermal transfer sheet according to claim 1, further comprising a light-to-heat conversion layer provided between the substrate and the thermal transfer layer.

11. A thermal transfer sheet according to claim 10, wherein the light-to-heat conversion layer contains a cyanine dye or phthalocyanine dye as a substance capable of converting light to heat.

12. A thermal transfer sheet according to claim 1, wherein a light-to-heat conversion layer, a heat-sensitive peelable layer, and the thermal transfer layer are laminated on the substrate in that order, and the light absorptance of the heat-sensitive peelable layer with respect to visible light is 50% or less.

13. A method of thermal transfer recording for recording an image comprising the step of using a thermal transfer sheet according to claim 1 for recording an image.

14. A method of thermal transfer recording according to claim 13, further comprising the step of forming an image on the transfer sheet by using a heating device.

15. A method of thermal transfer recording according to claim 13, further comprising the step of forming an image on the transfer sheet by using laser irradiation, which is controlled imagewise by electric signals.
